(19) United States
(12) Patent Application Publication
(10) Pub. No.: US 2004/0119189 A1
(43) Pub. Date: Jun. 24, 2004

(54) Indicia on foam core support media

(75) Inventors: Margaret J. Helber, Rochester, NY (US); Peter T. Aylward, Hilton, NY (US)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/328,335

(22) Filed: Dec. 23, 2002

(51) Int. Cl. B29C 59/00

(52) U.S. Cl. 264/132

(57) ABSTRACT

The present invention relates to a method for placing indicia on a support for an imaging element comprising providing a support wherein the support comprises a closed cell foam core layer and adhered thereto at least one flange layer, wherein the closed cell foam core layer comprises a polymer that has been expanded through the use of a blowing agent, and placing indicia on the support, wherein the imaging element comprises the support and at least one imaging layer. The invention also relates to a method for placing indicia on a support for an imaging element comprising providing a support wherein the support comprises a closed cell foam core layer and adhered thereto at least one flange layer, wherein the closed cell foam core layer comprises a polymer that has been expanded through the use of a blowing agent, and placing indicia on the closed cell foam core layer.

### CROSS REFERENCE TO RELATED APPLICATIONS

Reference is made to commonly assigned, co-pending U.S. patent application:

Ser. No. ______ by Helber et al. (Docket 84300) filed of even date herewith entitled “Embossed Indicia On Foam Core Imaging Media”; and

Ser. No. ______ by Helber et al. (Docket 84299) filed of even date herewith entitled “Process Survivable Indicia On Foam Core Imaging Supports”, the disclosures of which are incorporated herein.

### FIELD OF THE INVENTION

The present invention relates to a method of placing indicia on closed cell foam core supports.

### BACKGROUND OF THE INVENTION

In order for a print imaging support to be widely accepted by the consumer for imaging applications, it has to meet requirements for preferred basis weight, caliper, stiffness, smoothness, gloss, whiteness, and opacity. Supports with properties outside the typical range for ‘imaging media’ suffer low consumer acceptance.

In addition to these fundamental requirements, imaging supports are subject to other specific requirements depending upon the mode of image formation onto the support. For example, in the formation of photographic paper, it is important that the photographic paper be resistant to penetration by liquid processing chemicals, failing which, a stain appears on the print border accompanied by a severe loss in image quality. In the formation of ‘photo-quality’ ink jet paper, it is important that the paper is readily wetted by ink and that it exhibits the ability to absorb high concentrations of ink and dry quickly. If the ink is not absorbed quickly, the elements block (stick) together when stacked against subsequent prints and exhibit smudging and uneven print density. For thermal media, it is important that the support contain an insulative layer in order to maximize the transfer of dye from the donor, which results in higher color saturation.

It is important, therefore, for an imaging media to simultaneously satisfy several requirements. One commonly used technique in the art for simultaneously satisfying multiple requirements is through the use of composite structures comprising multiple layers wherein each of the layers, either individually or synergistically, serves distinct functions. For example, it is known that a conventional photographic paper comprises a cellulose paper base or support that has applied thereto a layer of polyolefin resin, typically polyethylene, on each side, which serves to provide waterproofing to the paper and also provides a smooth surface on which the photosensitive layers are formed. In U.S. Pat. No. 5,866,282, biaxially oriented polyolefin sheets are extrusion laminated to cellulose paper to create a support for silver halide imaging layers. The biaxially oriented sheets described therein have a microvoided layer in combination with coextruded layers that contain white pigments such as titanium dioxide above and below the microvoided layer. The composite imaging support structure described has been found to be more durable, sharper, and brighter than prior art photographic paper imaging supports that use cast melt extruded polyethylene layers coated on cellulose paper. In U.S. Pat. No. 5,851,651, porous coatings comprising inorganic pigments and anionic, organic binders are blade coated to cellulose paper to create ‘photo-quality’ ink jet paper.

In all of the above imaging supports, multiple operations are required to manufacture and assemble the individual layers into a support. For example, photographic paper typically requires a paper-making operation followed by a polyethylene extrusion coating operation, or as disclosed in U.S. Pat. No. 5,866,282, a paper-making operation is followed by a lamination operation for which the laminates are made in yet another extrusion casting operation. There is a need for imaging supports that can be manufactured in a single in-line manufacturing process while still meeting the stringent features and quality requirements of imaging supports.

It is also well known in the art that traditional imaging supports consist of raw paper support. For example, in typical photographic paper as currently made, approximately 75% of the weight of the photographic paper comprises the raw paper support. Although raw paper support is typically a high modulus, low cost material, there exist significant environmental issues with the paper manufacturing process. There is a need for alternate raw materials and manufacturing processes that are more environmentally friendly. Additionally to minimize environmental impact, it is important to reduce the raw paper support content, where possible, without sacrificing the imaging support features that are valued by the customer, that is, strength, stiffness, and surface properties of the imaging support.

An important corollary of the above is the ability to recycle photographic paper. Current photographic papers cannot be recycled because they are composites of polyethylene and raw paper support and, as such, cannot be recycled using polymer recovery processes or paper recovery processes. A photographic paper that comprises significantly higher contents of polymer lends itself to recycling using polymer recovery processes.

Existing composite color paper structures are typically subject to curl through the manufacturing, finishing, and processing operations. This curl is primarily due to internal stresses that are built into the various layers of the composite structure during manufacturing and drying operations, as well as during storage operations (core-set curl). Additionally, since the different layers of the composite structure exhibit different susceptibility to humidity, the curl of the imaging support changes as a function of the humidity of its immediate environment. There is a need for an imaging support that minimizes curl sensitivity as a function of humidity, or ideally, does not exhibit curl sensitivity.

The stringent and varied requirements of imaging media, therefore, demand a constant evolution of material and processing technology. One such technology known in the art as ‘polymer foams’ has previously found significant application in food and drink containers, packaging, furniture, and appliances. Polymer foams have also been referred to as cellular polymers, foamed plastic, or expanded plastic. Polymer foams are multiple phase systems comprising a solid polymer matrix that is continuous and a gas phase. For example, U.S. Pat. No. 4,832,775 discloses a composite foam/film structure which comprises a polystyrene foam support, oriented polypropylene film applied to at least one major surface of the polystyrene foam support, and an acrylic adhesive component securing the polypropylene film to the major surface of the polystyrene foam support. The foregoing composite foam/film structure can be shaped by conventional processes as thermoforming to provide numerous types of useful articles including cups, bowls, and plates, as well as cartons and containers that exhibit excellent levels of puncture, flex-crack, grease and abrasion resistance, moisture barrier properties, and resiliency.

Foams have also found limited application in imaging media. For example, JP 2839905 B2 discloses a 3-layer structure comprising a foamed polyolefin layer on the image-receiving side, raw paper support, and a polyethylene resin coat on the backside. The foamed resin layer was created by extruding a mixture of 20 weight % titanium dioxide master batch in low density polyethylene, 78 weight % polypropylene, and 2 weight % of Daiblow PE-M20 (AL)NK blowing agent through a T-die. This foamed sheet was then laminated to the paper support using a hot melt adhesive. The disclosure JP 09127648 A highlights a variation of the JP 2839905 B2 structure, in which the resin on the backside of the paper support is foamed, while the image receiving side resin layer is unfoamed. Another variation is a 4-layer structure highlighted in JP 09106038 A. In this, the image receiving resin layer comprises 2 layers, an unfoamed resin layer which is in contact with the emulsion, and a foamed resin layer which is adhered to the paper support. There are several problems with this, however. Structures described in the foregoing patents need to use foamed layers as thin as 10 μm to 45 μm, since the foamed resin layers are being used to replace existing resin coated layers onto the paper support. The thickness restriction is further needed to maintain the structural integrity of the photographic paper support since the raw paper support is providing the stiffness. It is known by those versed in the art of foaming that it is very difficult to make thin uniform foamed films with substantial reduction in density especially in the thickness range noted above.

Currently, backside indicia are provided by applying indicia directly to the support paper prior to the extrusion coating of a melt polymer. It is important to customers to be able to identify the source of their imaging prints to assure good quality that will preserve their memories. It is also important to provide print and other information on the backside of imaging media. Such information is useful in not only identifying the quality of manufacture of the imaging media, but may also be useful in providing information during the manufacturing process. By placing indicia on the support, it is feasible to track a support or part of a support during manufacture, such as tracking lanes within a wide master roll. Such a means is useful if there is a linear type imperfections that can be trimmed in a later operation instead of waiting the entire master roll.

During the manufacturing of imaging media numerous operations require linear measurement of continuous webs for the purposes of minimizing production waste and providing proper customer size product. The current method of measurement is generally a contact method. This method may be subject to inaccuracy caused by nonuniformity in web conveyance and web surface friction. Physical damage to the web material can occur through the use of contact measurement devices.

Assignment of defective locations within a web is provided using linear measurements. These measurements provide an approximate location for a manual inspection in a separate operation. Large rolls of photographic paper are slit in accordance with customer orders using equipment requiring time consuming operator set up. Locations identified as containing imperfections are removed during the slitting operation.

During the usage of photographic paper, there are several operations, which require measurement and alignment of both web and sheet materials. In the printing of web material, it is common for the exposing equipment to create an indexing punch hole between each exposure and also between customer orders. These punch holes are later removed in a chopping operation after photoprocessing has occurred. To advance the web material the proper distance for each exposure, a variety of metering rollers and stepper motors are used in conjunction with sensors that detect the punch holes. It is not uncommon for difficulties to arise during the handling and indexing of web materials, such as missed punch holes.

The application of indicia in current manufacturing processes is limited by drying capacity and dimensional change due to the rewetting of the support paper during the application of indicia, therefore restricting the amount of ink that can be applied. The conventional application of indicia to paper support requires the print to be dried. One disadvantage of paper is that it absorbs water as the indicia are applied to the paper support. Furthermore, the paper tends to absorb processing chemicals that can leave unsightly stains on the edge of the sheet. This detracts from the viewing pleasure of the print. In the formation of photographic color paper with printed indicia on the back of the support paper, there is a problem with the thickness of the paper being consistent in the areas of printing as the fibers swell during printing. The use of the closed cell foam core layer carrying indicia eliminates the problem of inconsistencies of the support paper caused by swelling during printing.

There is a need for a reliable, low cost, and high quality method of printing information and illustrations on the back of closed cell foam core imaging materials, particularly color photographic imaging media. There is a need for a reliable, low cost, and high quality method of measuring the displacement and cross web locations of web materials, particularly color photographic flange layer coated closed cell polymeric foam core media. There is a further need to provide a cleaner environment for imaging equipment, particularly photographic printers, in order to reduce the generation of paper dust and other related dirt resulting from the index hole punching operations currently in use. The present invention provides a reliable, low cost, and high quality method to place indicia on closed cell foam core imaging media which has been coated with at least one flange layer.

### SUMMARY OF THE INVENTION

The present invention relates to a method for placing indicia on a support for an imaging element comprising providing a support wherein the support comprises a closed cell foam core layer and adhered thereto at least one flange layer, wherein the closed cell foam core layer comprises a polymer that has been expanded through the use of a blowing agent, and placing indicia on the support, wherein the imaging element comprises the support and at least one imaging layer. The invention includes a method for placing indicia on a support for an imaging element comprising providing a support wherein the support comprises a closed cell foam core layer and adhered thereto an upper flange layer and a lower flange layer, wherein the closed cell foam core layer comprises a polymer that has been expanded through the use of a blowing agent, and placing indicia on at least one of the upper and lower flange layer. The invention also relates to a method for placing indicia on a support for an imaging element comprising providing a support wherein the support comprises a closed cell foam core layer and adhered thereto at least one flange layer, wherein the closed cell foam core layer comprises a polymer that has been expanded through the use of a blowing agent, and placing indicia on the closed cell foam core layer.

### ADVANTAGEOUS EFFECT OF THE INVENTION

The invention provides a closed cell foam core imaging element that has indicia, preferably on the backside. Such backside indicia may include a visible logo or a machine readable indicia, not visible to the human eye under daylight illuminance, on the back of the closed cell foam core layer. These indicia are provided at low cost and may be applied at high speed to provide a means for more accurate measurement. Such indicia may be used to provide information during the manufacturing process or as a means for the consumer to identify that their prints are made by a high quality manufacture. The indicia on the closed cell foam core layer provide a unique look, which is slightly muted and soft in appearance, to the imaging support. The indicia may be printed on the closed cell foam core layer under the backside flange layer or it may be printed on the outer portion of the backside flange layer or embossed into the backside flange layer. Flange layer coated closed cell foam core layers are desirable because they are light weight but can be made very stiff. This support is also recyclable because it does not contain any paper fiber.

This invention also provides indicia on a superior imaging support. Specifically, the printed indicia imaging element had high stiffness, excellent smoothness, high opacity, and excellent humidity curl resistance. The closed cell polymeric foam core imaging element can be effectively recycled because it does not contain any paper fiber.

### DETAILED DESCRIPTION OF THE INVENTION

The present invention relates to a method for placing indicia on an imaging element, specifically on a support comprising a closed cell foam core layer with at least one flange layer adhered thereto. The supports useful in the method of the invention comprise a support having a closed cell foam core layer, comprising a polymer that has expanded through the use of a blowing agent, and at least one flange layer, and most preferably, an upper and lower flange layer. The closed cell foam core layer comprises a homopolymer such as a polyolefin, polystyrene, polyvinylchloride or other typical thermoplastic polymers; their copolymers or their blends thereof; or other polymeric systems like polyurethanes, polyisocyanurates that has been expanded through the use of a blowing agent to consist of two phases, a solid polymer matrix, and a gaseous phase. Other solid phases may be present in the foams in the form of fillers that are of organic (polymeric, fibrous) or inorganic (glass, ceramic, metal) origin. The fillers may be used for physical, optical (lightness, whiteness, and opacity), chemical, or processing property enhancements of the foam.

The foaming of these polymers may be carried out through several mechanical, chemical, or physical means. Mechanical methods include whipping a gas into a polymer melt, solution, or suspension, which then hardens either by catalytic action or heat or both, thus entrapping the gas bubbles in the matrix. Chemical methods include such techniques as the thermal decomposition of chemical blowing agents generating gases such as nitrogen or carbon dioxide by the application of heat or through exothermic heat of reaction during polymerization. Physical methods include such techniques as the expansion of a gas dissolved in a polymer mass upon reduction of system pressure; the volatilization of low-boiling liquids such as fluorocarbons or methylene chloride, or the incorporation of hollow microspheres in a polymer matrix. The choice of foaming technique is dictated by desired foam density reduction, desired properties, and manufacturing process.

In a preferred embodiment used with this invention, polyolefins such as polyethylene and polypropylene, their blends and their copolymers are used as the matrix polymer in the closed cell foam core layer along with a chemical blowing agent such as sodium bicarbonate and its mixture with citric acid, organic acid salts, azodicarbonamide, azobisformamide, azobisisobutyroInitrile, diazoaminobenzene, 4,4′-oxybis(benzene sulfonyl hydrazide) (OBSH), N,N′-dinitrosopentamethyltetramine (DNPA), sodium borohydride, and other blowing agent agents well known in the art. The preferred chemical blowing agents would be sodium bicarbonate/citric acid mixtures, azodicarbonamide; though others may also be used. If necessary, these foaming agents may be used together with an auxiliary foaming agent, nucleating agent, and a cross-linking agent.

The range in density reduction of the closed cell foam core layer is from 20% to 95%. The preferred range in density reduction is from 40% to 70%. This is because it is difficult to manufacture a uniform product with very high density reduction (over 70%). Density reduction is the percent difference between solid polymer and a particular foam sample. It is also not economical to manufacture a product with density reduction less than 40%.

In another preferred embodiment, the method for placing indicia on a support for an imaging element comprises providing a support comprising a closed cell foam core layer or sheet and adhered thereto at least one flange layer, wherein the closed cell foam core layer comprises a polymer that has been expanded through the use of a blowing agent, and placing indicia on the closed cell foam core layer. In this embodiment, the closed cell foam core layer may be cast extruded and then stretched in at least one direction and then indicia is printed on the backside of the closed cell foam core layer. At least one flange layer may then further be adhered to the indiciaed closed cell foam core layer.

The flange layers, useful with this invention, are chosen to satisfy specific requirements of flexural modulus, caliper, surface roughness, and optical properties such as colorimetry and opacity. Imaging elements are constrained to a range in stiffness and caliper. At stiffness below a certain minimum stiffness, there is a problem with the element in print stackability and print conveyance during transport through photofinishing equipment, particularly high speed photoprocessors. It is believed that there is a minimum cross direction stiffness of 60 mN required for effective transport through photofinishing equipment. At stiffness above a certain maximum, there is a problem with the element in cutting, punching, slitting, and chopping during transport through photofinishing equipment. It is believed that there is a maximum machine direction stiffness of 300 mN for effective transport through photofinishing equipment. It is also important for the same transport reasons through photofinishing equipment that the caliper of the imaging element be constrained from 75 μm to 350 μM.

Imaging elements are typically constrained by consumer performance and present processing machine restrictions to a stiffness range of from approximately 50 mN to 250 mN and a caliper range of from approximately 100 μm to 400 μm. In the design of the element used in the invention, there exists a relationship between stiffness of the imaging element and the caliper and modulus of the closed cell foam core layer and modulus of the flange layers, that is, for a given core thickness, the stiffness of the element may be altered by changing the caliper of the flange layers and/or changing the modulus of the flange layers and/or changing the modulus of the closed cell foam core layer.

If the target overall stiffness and caliper of the imaging element are specified then for a given core thickness and core material, the target caliper and modulus of the flange layers are implicitly constrained. Conversely, given a target stiffness and caliper of the imaging element for a given caliper and modulus of the flange layers, the core thickness and core modulus are implicitly constrained.

Embodiments useful with this invention may have support thickness range of from 100 to 400 μm with ranges of closed cell foam core layer caliper and modulus and flange layer caliper and modulus follow: the preferred caliper of the closed cell foam core layer used in the invention ranges from 25 μm to 350 μm, the caliper of the polymer flange layers used in the invention ranges from 10 μm to 150 μm, the modulus of the closed cell foam core layer used in the invention ranges from 30 MPa to 1000 MPa, and the modulus of the flange layers used in the invention ranges from 700 MPa to 10500 MPa. In each case, the above range is preferred because of (a) consumer preference, (b) manufacturability, and (c) materials selection. It is noted that the final choice of flange layer and core materials, modulus, and caliper will be a subject of the target overall element stiffness and caliper. In additional embodiments useful in the method of this invention, the flange layers are integral to the closed cell foam core layer. This configuration is desirable to help simplify the manufacturing process as well as improving the adhesion of the flange layer to the closed cell foam core layer.

The selection of core material, the extent of density reduction (foaming), and the use of any additives/treatments for, for example, cross-linking the foam, determine the closed cell foam core layer modulus. The selection of flange layer materials and treatments (for example, the addition of strength agents for paper support or the use of filler materials for polymeric flange layer materials) determines the flange layer modulus.

For example, at the low end of target stiffness (50 mN) and caliper (100 μm), given a typical polyolefin foam of caliper 50 μm and modulus 137.9 MPa, the flange layer caliper is then constrained to 25 μm on each side of the core, and the flange layer modulus should be 10343 MPa, properties that may be met using a high modulus paper support. Also, for example, at the high end of target stiffness (250 mN) and caliper (400 μm), given a typical polyolefin foam of caliper 300 μm and modulus 137.9 MPa, the flange layer caliper is constrained to 50 μm on each side and the flange layer modulus should be 1034 MPa, properties that may be met using a polyolefin flange layer. In another embodiment useful with the present invention, the upper and lower flange layers have a modulus greater than the modulus of the closed cell foam core layer.

In another preferred lamination embodiment useful with this invention, the flange layers used comprise high modulus polymers such as high density polyethylene, polypropylene, or polystyrene; their blends or their copolymers; that have been stretched and oriented. They may be filled with suitable filler materials as to increase the modulus of the polymer and enhance other properties such as opacity and smoothness. Some of the commonly used inorganic filler materials are talc, clays, calcium carbonate, magnesium carbonate, barium sulfate, mica, aluminum hydroxide (trihydrate), wollastonite, glass fibers and spheres, silica, various silicates, and carbon black. Some of the organic fillers used are wood flour, jute fibers, sisal fibers, and polyester fibers. The preferred fillers are talc, mica, and calcium carbonate because they provide excellent modulus enhancing properties. Polymer flange layers useful to this invention are of caliper from 10 μm to 150 μm, preferably from 35 μm to 70 μm.

In a further embodiment useful in this invention, the closed cell foam core layer may be laminated with at least one sheet of preformed biaxially oriented polymer as the flange layer. In this case, the backside biaxially oriented sheet may be preprinted. In this embodiment the use of multicolor may be introduced to the closed cell foam core imaging element.

The biaxially oriented sheet may be applied to the closed cell foam core layer by the use of an adhesive. The adhesive may be any suitable material that will maintain the integrity between the closed cell foam core layer and the biaxially oriented sheet under processing conditions and the condition of use of the photograph and not compromise the integrity of the machine readable or human readable printing on the sheet. Typical lamination adhesives are solvent based adhesives, such as urethanes, water based adhesives such as acrylics and latex, and 100% solids adhesives such as urethanes.

Extruded polyolefins may also be used to apply the biaxially oriented sheet to the closed cell foam core layer. An extruder is used to melt and continuously apply a uniform layer of molten polyolefin directly between the biaxially oriented sheet and the closed cell foam core layer. Bonding is achieved as the molten resin resolidifies in position on the chill roll. Suitable polyolefins for extrusion lamination include polypropylene, polyethylene, polymethylpentene, polystyrene, polybutylene, and mixtures thereof. Polyolefin copolymers, including copolymers of propylene and ethylene such as hexene, butene, and octene are also useful.

In another embodiment useful with the method of this invention, the flange layers used comprise paper on at least one side and a high modulus polymeric material on the other side. In another embodiment, an integral skin may be on one side and another skin laminated to the other side of the closed cell foam core layer. The caliper of the paper and of the high modulus polymeric material is determined by the respective flexural modulus such that the overall stiffness of the imaging element lies within the preferred range, and the bending moment around the central axis is balanced to prevent excessive curl. Other embodiment that may be useful in this invention comprise an upper flange layer of paper, a lower flange layer of paper or both an upper and a lower flange layer of paper. Paper is desirable because of it very high modulus properties which is desirable for high stiffness application. The paper flange layer may have a caliper from 25 μm to 100 μm. and preferable has a caliper from 30 μm to 70 μm.

In preferred support comprising paper for use in the present invention, the element comprises less than 75% by weight of raw paper. In a preferred embodiment imaging member comprises less than 50% by weight of raw paper.

A further method useful in this invention for placing indicia on a support for an imaging element comprises providing a support wherein the support comprises a closed cell foam core layer and adhered thereto an upper flange layer and a lower flange layer, wherein the closed cell foam core layer comprises a polymer that has been expanded through the use of a blowing agent, and placing indicia on at least one of the upper and lower flange layer. In an especially preferred embodiment, the indicia is placed on the outermost surface of the imaging element, most preferably the outermost layer on the backside of the imaging element, that is, the side opposite the imaging layer or layers.

In one useful embodiment for use with this invention, the flange layer may comprise pigment. One pigment that is useful in enhancing the opacity as well as the stiffness of the flange layer is talc. Another useful pigment that may be added to the flange layer is titanium dioxide. This pigment has a very high refractive index and is desired for its hiding power. This is particularly useful to minimize show-through, when indicia are printed on the imaging element. Titanium dioxide is also useful for its high whiteness properties. This is desirable for imaging print and providing whiter whites. Other pigments may be used as well.

The element, while described as having preferably at least three layers of a closed cell foam core and a flange layer on each side, may also be provided with additional layers that may serve to change the properties of the element. Imaging elements could be formed with surface layers that would provide an improved adhesion or look.

These elements may be coated or treated after the coextrusion and orienting process or between casting and full orientation with any number of coatings which may be used to improve the properties of the sheets including printability, to provide a vapor barrier, to make them heat sealable, or to improve the adhesion to the support or to the photosensitive layers. Examples of this would be acrylic coatings for printability, coating polyvinylidene chloride for heat seal properties. Further examples include flame, plasma, or corona discharge treatment to improve printability or adhesion.

In an embodiment useful with this invention, the closed cell form core with at least one flange layer has a layer of polyethylene on each side of the support. Polyethylene is desirable for photographic application because it has good wet and dry adhesion to the gelatin used in the imaging layer. Also in general a wider variety of binder stick to polyethylene for printed indicia.

The elements used in the invention may be made using several different manufacturing methods. The flange layers may be formed integrally with the closed cell foam core layer by manufacturing the closed cell foam core layer with a flange layer skin sheet or the flange layer may be laminated to the closed cell foam core layer material. The integral extrusion of flange layers with the core is preferred for cost reduction. In another embodiment used in this invention, the flange layer may be an oriented layer and it is adhesively attached to the closed cell foam core layer as a preformed sheet and in a preferred embodiment the flange layer is a biaxially oriented polyolefin layer.

The lamination technique allows a wider range of properties and materials to be used for the skin materials. The coextrusion, quenching, orienting, and heat setting of the element may be effected by any process which is known in the art for producing oriented sheet, such as by a flat sheet process or a bubble or tubular process. The flat sheet process involves extruding the blend through a slit die and rapidly quenching the extruded web upon a chilled casting drum so that the closed cell foam core layer component of the element and the polymeric integral flange layer components are quenched below their glass solidification temperature. The flange layer components may be extruded through a multiple stream die with the outer flange layer forming polymer streams not containing foaming agent. Alternatively, the surface of the foaming agent containing polymer may be cooled to prevent surface foaming and form a flange layer. The quenched sheet is then biaxially oriented by stretching in mutually perpendicular directions at a temperature above the glass transition temperature and below the melting temperature of the matrix polymers. The sheet may be stretched in one direction and then in a second direction or may be simultaneously stretched in both directions. After the sheet has been stretched, it is heat set by heating to a temperature sufficient to crystallize or anneal the polymers while restraining, to some degree, the sheet against retraction in both directions of stretching.

The element may also be made through the extrusion laminating process. Extrusion laminating is carried out by bringing together the paper or polymeric flange layers used with the invention and the closed cell foam core layer with application of an adhesive between them, followed by their being pressed in a nip such as between two rollers. The adhesive may be applied to either the flange layers or the closed cell foam core layer prior to their being brought into the nip. In a preferred form, the adhesive is applied into the nip simultaneously with the flange layers and the closed cell foam core layer. The adhesive may be any suitable material that does not have a harmful effect upon the element. A preferred material is polyethylene that is melted at the time it is placed into the nip between the closed cell foam core layer and the flange layer. Addenda may also be added to the adhesive layer. Any know material used in the art to improve the optical performance of the system may be used. The use of titanium dioxide is preferred. During the lamination process also, it is desirable to maintain control of the tension of the flange layers in order to minimize curl in the resulting laminated receiver support.

In addition to the stiffness and caliper, an imaging element needs to meet constraints in surface smoothness and optical properties such as opacity and colorimetry. In one embodiment used in the present invention, the support, and preferably the upper flange layer, may have a roughness of from 0.1 μm to 1.1 μM. Surface smoothness characteristics may be met during flange layer-sheet manufacturing operations such as during paper making or during the manufacture of oriented polymers like oriented polystyrene. Alternatively, it may be met by extrusion coating additional layer(s) of polymers such as polyethylene onto the flange layers in contact with a textured chill-roll or similar technique known by those skilled in the art.

Optical properties such as opacity and colorimetry may be met by the appropriate use of filler materials such as titanium dioxide and calcium carbonate and colorants, dyes and/or optical brighteners or other additives known to those skilled in the art. The fillers may be in the flange layer or an overcoat layer, such as polyethylene. Generally, support materials for color print imaging materials are white, possibly with a blue tint as a slight blue is preferred to form a preferred white look to whites in an image. Any suitable white pigment may be incorporated in the polyolefin layer such as, for example, titanium dioxide, zinc oxide, zinc sulfide, zirconium dioxide, white lead, lead sulfate, lead chloride, lead aluminate, lead phthalate, antimony trioxide, white bismuth, tin oxide, white manganese, white tungsten, and combinations thereof. The pigment is used in any form that is conveniently dispersed within the flange layer or resin coat layers. The preferred pigment is titanium dioxide. In addition, suitable optical brightener may be employed in the polyolefin layer including those described in Research Disclosure, Vol. No. 308, December 1989, Publication 308119, Paragraph V, page 998.

In an embodiment useful with this invention, it is useful to have a support comprising a closed cell foam core layer with flange layers with opacity of from 80 to 99%. In a further embodiment, at least one flange layer has opacity from 80 to 99 percent and a preferred opacity of greater than 90%. Being able to provide the bulk of the imaging element's opacity within the flange layer is desirable to help minimize loading the closed cell foam core layer with pigments. In other useful embodiments it may be useful to provide opacity in the closed cell foam core layer, as well as the flange layer. In another useful embodiment it may be desirable to have opacity in the top flange layer and the closed cell foam core layer and a transparent backside flange layer to allow easier viewing of the print indicia when it is placed on the closed cell foam core layer adjacent to the backside flange layer. Other pigments useful in this invention may include CaCo3, BaSO4, clays, ZnO, and ZnS.

In addition, it may be necessary to use various additives such as antioxidants, slip agents, or lubricants, and light stabilizers in the plastic elements as well as biocides in the paper elements. These additives are added to improve, among other things, the dispersibility of fillers and/or colorants, as well as the thermal and color stability during processing and the manufacturability and the longevity of the finished article. For example, the polyolefin coating may contain antioxidants such as 4,4′-butylidene-bis(6-tert-butyl-meta-cresol), di-lauryl-3,3′-thiopropionate, N-butylated-p-aminophenol, 2,6-di-tert-butyl-p-cresol, 2,2-di-tert-butyl-4-methyl-phenol, N,N-disalicylidene-1,2-diaminopropane, tetra(2,4-tert-butylphenyl)-4,4′-diphenyl diphosphonite, octadecyl 3-(3′,5′-di-tert-butyl-4′-hydroxyphenyl propionate), combinations of the above; heat stabilizers, such as higher aliphatic acid metal salts such as magnesium stearate, calcium stearate, zinc stearate, aluminum stearate, calcium palmitate, zirconium octylate, sodium laurate, and salts of benzoic acid such as sodium benzoate, calcium benzoate, magnesium benzoate and zinc benzoate; light stabilizers such as hindered amine light stabilizers (HALS), of which a preferred example is poly{[6-[(1,1,3,3-tetramethylbutylamino}-1,3,5-triazine-4-piperidinyl)-imino]-1,6-hexanediyl[{2,2,6,6-tetramethyl-4-piperdinyl)imino]} (Chimassorb 944 LD/FL).

Indicia useful in this invention may be traditional logos to provide the consumer with brand recognition, or machine readable indicia on the back of closed cell foam core layer or to the back of flange layer coated closed cell foam core layer, which allow for planar metrology of web and sheet material without contact. The indicia used in this invention may be either printed or embossed. The indicia may be engraved on the roller by several means such as laser or mechanical engraving, or chemical etching processes. The indicia may form a character, or a logo with at least one character. In other useful embodiments, the indicia, such as characters, may comprises at least one member selected from the group consisting of letters, pictures, numbers, symbols, and words. An additional useful embodiment of this invention would be to apply ink or colored material to the embossed logo indicia area or to the background area and not the logo indicia in order to provide indicia that are easier to view and is less angular dependant when viewing. Such ink or colored solution may be aqueous or solvent-based.

“Planar metrology” as used in this application, is defined as point to point measurement of length through the use of predetermined coordinate systems. In a preferred case, rectangular coordinates are used for linear metrology. “Linear Metrology” as used in this application is defined to be the straight line measurement between two points. In web or sheet material applications, both machine and cross machine direction measurements are typically employed. Of particular interest are machine direction measurements. The use of indicia not visible to the human eye under daylight illuminance may be applied to linear metrology of high speed webs without surface contact. The indicia may also be analyzed against time to evaluate and control web speed and linear movement. Indicia further provide the accurate mapping of potentially defective areas of a web, and allow for the precise and rapid locating of such areas for removal. The use of different non-uniformly spaced patterns of indicia may be used to encode a variety of measurements in either the cross web or machine direction. The spacing of indicia should match the capabilities of the equipment that applies and senses the indicia. A practical range of spacing for either uniform or non-uniform spacing is from 1 mm to 1 m. A preferred range for use with this invention is from 1 mm to 1 cm. This invention provides the indexing required during photofinishing printing operations and eliminates the need for indexing punch holes. The application of the indicia on the backside of the closed cell foam core layer also eliminates the need to dry the print, as is the case with conventional imaging element that comprise paper support. The use of the closed cell foam core layer carrying indicia eliminates the problem of inconsistencies of the support paper caused by swelling during printing.

Suitable visible and invisible, that is, inks not visible to the human eye under daylight illuminance, for use with this invention include solvent based inks, aqueous based inks, and radiation cured inks. Ink formulas used in the printing industry need to provide a variety of functions. In an effort to print on a particular substrate, the inks needs to provide good adhesion, wear resistances and also have chemical compatibility. Printing inks also need to be formulated and optimize to the printing method in which it is to be applied. For instances, in a gravure printing method the ink formula needs to have its viscosity adjusted for good release from the roller cells. Additionally the ink formula needs to be able to wet the substrate. This may be accomplished by the addition of solvents, lowering the solids of the formulations or adding addenda such as surfactants. The web substrate may also be pretreated such as a corona discharge treatment, flame treatment or perhaps priming the web surface to be printed. The inks also have to be pleasing to the viewing in-order to convey a sense of quality. Often the print helps to sell the product it is associated with.

When applying ink to a polymer based non-porous substrate, such as polypropylene or a pigment-filled polypropylene, the binder selection is facilitates good adhesion. When the substrate to be printed is to be used for imaging, such as in a photographic imaging substrate, the demands on the ink formula become even greater. If the print indicia is placed on the outer polymer layer, it is exposed to chemical processing conditions such as high and low pH conditions that may cause the ink binder to swell as well as physical abrasion in high speed processing equipment. Often the web is accelerated and decelerated at high rates, web conveyance often steers the web across rollers and other parts of a processor. In general the ink formula needs to survive some very unique conditions.

Another material in the ink formula is the pigment. This is the part of the formula that provides the color to the printed indicia. This needs to provide good color matching and also needs to provide some level of light (UV and visible) stability to the indicia. Pigments are dispersed in the vehicle, which is the liquid portion of the formula, such as water and solvent, that carries them. Generally, ink pigments may be classified as azo, polycyclic, acid dye based basic dye salts and inorganics. Azo materials may include monoazo, disazo, triazo and polyazo. Additional details may be obtained from The Printing Ink Manual 3^{rd} edition ISBN 7198 2528 8.

Pigments are colorants which are considered to be effectively insoluble in the application medium, and many such compounds are well known and in wide commercial use. Various classes of pigments are classified in the Pigments and Solvent Dyes section of the Color Index International, published by the Society of Dyers and Colorists in 1997, and there are of course many insoluble colorants which are not in this list. It is common practice to provide pigment compositions in the form of finely divided dispersions, which may be produced by well known methods such as ball milling, media milling or by the methods disclosed in U.S. Pat. No. 5,026,427 and U.S. Pat. No. 5,310,778.

Other pigments useful with this invention may include titanium dioxide, zinc based pigments, lead based pigments, antimony oxide, CaCO3, silicas, silicates such as aluminum silicate, natural calcium silicates, sodium aluminosilicates, magnesium silicate, micas, nepheline, magnesium aluminum silicate, and sulfate based pigments, such as BaSO4. Other useful materials may include oxides such as red, yellow, brown, zinc and magnesium ferrite, hydrated chromium oxide and chromic oxide. While these may be used for many imaging application, some care and added evaluation is needed when these and other materials are in photographic application. Some materials may cause photo reactivity with the light sensitive emulsion. Also, pigments may include chromates, such as chrome green, molybdate orange, lead chrome pigments, and cadmium based pigments. Again, some caution is need to assess photo reactivity issues as well as environmental problems. Additional pigments may include ferriferrocyanides, ultramarine pigments, nickel antimony titanate yellow, chrome antimony titanate, cobalt aluminate, manganese violet, manganese antimony, bismuth vanadate, molybdate yellow, nitroso pigments, monoazo based colors, disazo-based colors, disazo condensation pigments, basic-dye based pigments including alkali, quinacridone pigments, carbazole dioxazine, alizarine lake, vat pigments, phthalocanines, isoindoline-based pigments, tetrachloroisoindolinone-based pigments, pyrazoloquinazolone, black pigments such as carbon black, graphite, iron oxide, copper and chrome black, metallic pigments including aluminum flake, gold bronze flake, stainless steel flake, luminescent organic pigments, fluorescent and phosphorescent inorganic pigments. Additional details and information on other useful pigments for this invention may be obtained from the Pigment Handbook by Peter Lewis ISBN 0-8155-0811-5. Other useful material may include butanamide, pigment yellow 14, pigment yellow 74, the azo metal complex pigments, hydrocarbyl polypropyleneamine, tetrapropylenepentamine, tallowalkyl tripropylenetetramine, tallowalkyl dipropylenetriamine, cocoalkyl tetrapropylenepentamine, cocoalkyl tripropylenetetramine, cocoalkyl dipropylenetriamine, stearyl tetrapropylenepentamine, stearyl tripropylenetetramine, stearyl dipropylenetriamine, oleyl tetrapropylenepentamine, oleyl tripropylenetetramine, oleyl dipropylenetriamine, lauryl tetrapropylenepentamine, lauryl tripropylenetetramine, lauryl dipropylenetriamine, decyl tetrapropylenepentamine, decyl tripropylenetetramine, decyl dipropylenetriamine, myristyl tetrapropylenepentamine, myristyl tripropylenetetramine, myristyl dipropylenetriamine, palmyl tetrapropylenepentamine, palmyl tripropylenetetramine, palmyl dipropylenetriamine, isodecyl tetrapropylenepentamine, isodecyl tripropylenetetramine, and isodecyl dipropylenetriamine. Suitable organic pigments are, for example, those of the beta-naphthol, Naphthol AS, benzimidazolone, isoindolinone and isoindoline series, also polycyclic pigments for example from the phthalocyanine, quinacridone, perylene, perinone, thioindigo, anthraquinone, dioxazine, quinophthalone and diketopyrrolopyrrole series. Suitable pigments also include solid solutions of the pigments mentioned, mixtures of organic and/or inorganic pigments with organic and/or inorganic pigments such as, for example, carbon black, coated metal, mica or talc pigments, for example, mica CVD-coated with iron oxide, and also mixtures between the pigments mentioned. Other suitable pigments include flaked dyes such as Ca, Mg and Al lakes of sulpho- and/or carboxyl-containing dyes. Pigmented ink may also be purchased from supplier such as Kroma Corporation, Flint Ink, Sun Chemical and others. Whatever pigment is selected needs to be evaluated for overall performance within the photographic system, to assure that it does not leech into processing chemistry, change color, or interact with the photographic or other.

For purposes of the present invention, the term solvent refers to a wide variety of solid, liquid and gaseous substances but for the purpose of this invention, the disclosure will be based mostly on liquid base substances. Ink manufacturers make solutions and dispersions by mixing substances that may not spontaneously intermix on a molecular scale but remain in solution or suspension. For the purpose of a process survivable ink, it is desirable to have an ink that has high film forming properties at a relatively low viscosity, while the solvent must separate from the film and evaporate during drying. Solvents are used to dissolve or disperse solid phase materials in solution so they may be more easily printed and dried.

Ink solvents for printing may be selected from a number of solvents. It should be noted that make-ink formulas are a mixture of solvents and water. In general, if there is more than 50% water in the formula, it is termed water-based or aqueous. Some people also refer to water as a solvent. In the true chemical definition, water is a solvent. In general, solvents with a high hydroxyl content are strongly polar and high dielectric constant, while hydrocarbons and other solvents are non-polar and have a low dielectric constant. Solvents may be use as individually substances or they may be mixed to form co-solvents. Useful solvents must have a good solubility parameter and also an appropriate evaporation rate for the process in which they are used. Slow solvents with low volatility are necessary for printing press stability. The ability to control the rate of evaporation is important. The evaporation rate of a blend varies, based on the components, the concentration and the temperature. Volatility at a given temperature is largely determined by the vapor pressure and the heat of evaporation. It may also be necessary to provide a balance to an ink formula with solvents. In some cases, having an ink formula with a constant boiling temperature (azeotrope) may be desirable. Useful solvents may include, but are not limited to, aliphatic hydrocarbons, aromatic hydrocarbons such as benzene, toluene, xylene, napthhenic, monohydric alcohol, alipatic and alicyclic, glycol, glycol ether, ketone and esters. Typical alcohols include methyl, ethyl, propyl, butanols and their derivatives. Useful glycols include ethylene, propylene, hexlene, diethylene, dipropylene, triethylene and glycerine. Glycol ethers includes methylene glycol, methyl cellosolve, ethylene glycol, cellosolve, butyl glycol, butyl cellosolve, butyl digol and butyl carbitol and their derivatives. Ketones based materials include acetone, dimethyl ketone, methyl ethyl ketone, methyl iso-butyl ketone, cyclohexanone, isophorone, diacetone alcohol and mixtures thereof. Esters may include ethyl acetate, isopropyl acetate, n-butyl acetate.

Additionally, it may be necessary to add plasticizers to provide dried ink flexibility. These materials may also minimize the binder polymer from forming a surface skin during drying and trapping solvent in the print area. Useful plasticizers may include dibutyl phthalate, triethyl citrate or cyclohexanol phthalate. Additional materials may be found Raw Materials Data Handbook Volume 2 from the National Printing Ink research Institute. To improve wear resistance, improve slip and provide water repellency in the print area, it may be desirable to add waxes to the formulation. Useful waxes may include polyethylene waxes, polytetrafluoroethylene, fatty amides, halogenated hydrocarbon waxes, natural waxes, petroleum waxes.

In another embodiment useful in this invention, the imaging element comprises indicia that are machine detectable and not visible to the human eye under natural or artificial daylight illuminance wherein the machine detectable indicia comprises inks which respond to actinic radiation below 400 nanometers or above 700 nanometers. Such indicia not visible to the human eye under daylight illuminance may be applied to the closed cell foam core layer or to the flange layer. In a further embodiment the indicia may form a grid. When indicia not visible to the human eye under daylight illuminance is printed on the closed cell foam core layer, it may be desirable to have a transparent backside flange layer. In this case the use of pigments may interfere with the machine readability.

For the purpose of clarification, as used in this application “light” is the only type of electromagnetic radiation that is visible to the human eye. Other types of radiation, such as “infrared radiation” are not visible to the human eye because they have different wavelengths than light. “Light” has a wavelength range of 400 nm to 700 nm, which makes it visible to the human eye. Infrared radiation has a wavelength range beginning above 700 nm, generally at 800 nm which makes it invisible to the human eye, that is, not visible to the human eye under daylight illuminance. Similarly, ultraviolet radiation has a wavelength that is less than 400 nm, making it invisible to the human eye, that is, not visible to the human eye under daylight illuminance. When electromagnetic radiation of the appropriate wavelength range is applied to the printed web, the areas imprinted with indicia not visible to the human eye under daylight illuminance will respond by emitting electromagnetic radiation. The wavelength range of the emitted radiation is dependent on the specific characteristics of the dyes used. For example, Kodak I.R. 125 is a laser dye that emits electromagnetic radiation of 915 nm when exposed to radiation of 795 nm.

For a particular ink not visible to the human eye under daylight illuminance, there is a specific wavelength range of absorbtivity and reflectance. The source of illuminance is matched to the absorptivity of the indicia and a detector is matched to its reflectivity. Examples of solvent based inks include nitrocellulose maleic, nitrocellulose polyamide, nitrocellulose acrylic, nitrocellulose urethane, chlorinated rubber, vinyl, acrylic, alcohol soluble acrylic, cellulose acetate acrylic styrene, and other synthetic polymers. Examples of water based inks include acrylic emulsion, maleic resin dispersion styrene-maleic anhydride resins, and other synthetic polymers. Examples of radiation cured inks include ultraviolet and electron beam inks. The preferred ink systems for printing indicia are water based inks and radiation cured inks, because of the need to reduce volatile organic compounds associated with solvent based ink systems. Inks not visible to the human eye under daylight illuminance, as they are transparent, may be applied to the backside film web without altering the physical appearance of any designs on the web.

A substantially transparent magnetic recording layer may also be used to achieve the advantages of this invention. By “substantially transparent” it is meant that the magnetic particles are sufficiently dispersed and are of a size and distribution to permit substantial transmittance, for example, more than 63% of visible light through the magnetic recording layer. More specifically, the substantially transparent magnetic recording layer used with this invention increases the optical density of the backside biaxially oriented sheet by less than 0.2 optical density units across the visible portion of the spectrum from 400 nm to 700 nm.

The substantially transparent magnetic layer may be used in conjunction with human readable indicia, or symbology, of a plurality of colors. Such human readable indicia may be applied to the backside biaxially oriented sheet by methods well known in the art. The substantially transparent nature of the magnetic recording layer will permit viewing of the human readable symbology. In forming the transparent magnetic recording layer used with this invention, magnetic particles with a surface area of at least 30 m 2/g, and preferably with a surface area of at least 40 m²/g are applied in a layer having a dried thickness of less than 1.5 μm. The magnetic particles are homogeneously dispersed in a substantially transparent binder and a solvent for the binder. A preferred class of binders is cellulose organic acid esters. The preferred binder is cellulose acetate. Suitable solvents include methylene chloride, methyl alcohol, methyl ethyl ketone, methyl isobutyl ketone, ethyl acetate, butyl acetate, cyclohexanone, butyl alcohol, dimethylformamide as well as mixtures thereof. The dispersing medium may also contain transparent addenda such as plasticizers and dispersing agents.

A preferred method for placing indicia on a support for an imaging element comprises a support wherein the support comprises a closed cell foam core layer and adhered thereto at least one flange layer, wherein the closed cell foam core layer comprises a polymer that has been expanded through the use of a blowing agent, and placing indicia on the support. The indicia may be on the backside of the closed cell foam core layer under the backside flange layer or it may be on the outer most side of the backside flange layer.

The closed cell foam core layer utilized in the instant invention generally is printed on the backside of the imaging element. That is, the side opposite or furthest away from the image layers. The indicia may be on the closed cell foam core layer underneath the backside flange layer or it may be on the backside flange layer surface. When the indicia is placed under the backside flange layer, it is protected from the processing chemicals used in photographic processing. By placing the indicia on the closed cell foam core layer, it imparts a unique appearance to the indicia. The indicia have a very smooth muted appearance imparted by pigment placed in the backside flange layer that covers the closed cell foam core layer. Additionally, when the backside flange layer is essential free of pigments, the closed cell foam core layer has a speckle pattern of varying gloss. This provides a unique and exciting look to the imaging element backside, when the dyes or pigments of the indicia overlay the speckle pattern. The variable gloss of the closed cell foam core layer further enhances the appearance of the backside indicia when it is embossed into a backside transparent flange layer. The variable speckle gloss creates a striking appearance to the embossed indicia. The printing of the indicia generally is carried out by Flexographic printing, Rotogravure printing or digital printing. Flexography is an offset letterpress technique where the printing plates are made from rubber or photopolymers. The printing is accomplished by transfer of the ink from the raised surface of the printing plate to the material being printed. The Rotogravure method of printing uses a print cylinder with thousands of tiny cells, which are below the surface of the printing cylinder.

Another means useful in this invention for placing indicia on a closed cell foam core layer with at least one flange layer is to emboss the indicia into the backside flange layer. For embossing indicia, a roller, preferably a chill cylinder roll with a specially prepared surface, is employed for the application of indicia, such as different patterns or symbols, onto the backside of a polyolefin-coated support paper. The chill cylinder roll allows the polyolefin-extrusion coating and the characterization in one single in-line operational step. The chill cylinder roll is disposed on the machine frame in parallel to the pressure roll, thereby forming a nip between the pressure roll and the chill cylinder roll. Expanded and potentially oriented closed cell foam core layer may be passed through the nip between the pressure roll and the chill cylinder roll. A polymer coating layer is brought as a semi-fluid molten film through the nip between the chill cylinder roll and the pressure roll onto the surface of closed cell foam core layer for generating, simultaneously, a replication of the surface structure of the chill cylinder roll on the polymer coating layer. The chill cylinder roll surface structure difference causes a difference in the reflective properties of the polymer coated closed cell foam core imaging member between areas corresponding to the indicia pattern on the chill cylinder roll surface and the surrounding areas of the chill cylinder roll surface. This roughness difference between the indicia patterns, embossed into the polymer coating of the closed cell foam core layer and the area of the coating surrounding the indicia, such as patterns or symbols, is such that the higher disposed surface areas of the chill cylinder roll have a structure resulting in generation of a lower surface roughness level in first regions on the polymer coated closed cell foam core imaging member as compared to second regions of the polymer coated imaging corresponding to the lower disposed surface areas of the chill cylinder roll.

Used herein, the phrase ‘imaging element’ comprises an imaging support as described above along with an image receiving layer as applicable to multiple techniques governing the transfer of an image onto the imaging element. Such techniques include thermal dye transfer, electrophotographic printing, or ink jet printing, as well as a support for photographic silver halide images. As used herein, the phrase “photographic element” is a material that utilizes photosensitive silver halide in the formation of images.

The thermal dye image-receiving layer of the receiving elements useful with the invention may comprise, for example, a polycarbonate, a polyurethane, a polyester, polyvinyl chloride, poly(styrene-co-acrylonitrile), poly(caprolactone), or mixtures thereof. The dye image-receiving layer may be present in any amount that is effective for the intended purpose. In general, good results have been obtained at a concentration of from 1 to 10 g/m². An overcoat layer may be further coated over the dye-receiving layer, such as described in U.S. Pat. No. 4,775,657 of Harrison et al.

Dye-donor elements that are used with the dye-receiving element of the useful with the invention conventionally comprise a support having thereon a dye containing layer. Any dye may be used in the dye-donor employed in the invention, provided it is transferable to the dye-receiving layer by the action of heat. Especially good results have been obtained with sublimable dyes. Dye donors applicable for use in the present invention are described, for example, in U.S. Pat. Nos. 4,916,112; 4,927,803; and 5,023,228. As noted above, dye-donor elements are used to form a dye transfer image. Such a process comprises image-wise-heating a dye-donor element and transferring a dye image to a dye-receiving element as described above to form the dye transfer image. In a preferred embodiment of the thermal dye transfer method of printing, a dye donor element is employed which compromises a poly(ethylene terephthalate) support coated with sequential repeating areas of cyan, magenta, and yellow dye, and the dye transfer steps are sequentially performed for each color to obtain a three-color dye transfer image. When the process is only performed for a single color, then a monochrome dye transfer image is obtained.

Thermal printing heads, which may be used to transfer dye from dye-donor elements to receiving elements useful with the invention, are available commercially. There may be employed, for example, a Fujitsu Thermal Head (FTP-040 MCS001), a TDK Thermal Head F415 HH7-1089, or a Rohm Thermal Head KE 2008-F3. Alternatively, other known sources of energy for thermal dye transfer may be used, such as lasers as described in, for example, GB No. 2,083,726A.

A thermal dye transfer assemblage used with the invention comprises (a) a dye-donor element, and (b) a dye-receiving element as described above, the dye-receiving element being in a superposed relationship with the dye-donor element so that the dye layer of the donor element is in contact with the dye image-receiving layer of the receiving element.

When a three-color image is to be obtained, the above assemblage is formed on three occasions during the time when heat is applied by the thermal printing head. After the first dye is transferred, the elements are peeled apart. A second dye-donor element (or another area of the donor element with a different dye area) is then brought in register with the dye-receiving element and the process repeated. The third color is obtained in the same manner.

The electrographic and electrophotographic processes and their individual steps have been well described in the prior art. The processes incorporate the basic steps of creating an electrostatic image, developing that image with charged, colored particles (toner), optionally transferring the resulting developed image to a secondary substrate, and fixing the image to the substrate. There are numerous variations in these processes and basic steps; the use of liquid toners in place of dry toners is simply one of those variations.

The first basic step, creation of an electrostatic image, may be accomplished by a variety of methods. The electrophotographic process of copiers uses imagewise photodischarge, through analog or digital exposure, of a uniformly charged photoconductor. The photoconductor may be a single-use system, or it may be rechargeable and reimageable, like those based on selenium or organic photoreceptors.

In an alternate electrographic process, electrostatic images are created ionographically. The latent image is created on dielectric (charge-holding) medium, either paper or film. Voltage is applied to selected metal styli or writing nibs from an array of styli spaced across the width of the medium, causing a dielectric breakdown of the air between the selected styli and the medium. Ions are created, which form the latent image on the medium.

Electrostatic images, however generated, are developed with oppositely charged toner particles. For development with liquid toners, the liquid developer is brought into direct contact with the electrostatic image. Usually a flowing liquid is employed to ensure that sufficient toner particles are available for development. The field created by the electrostatic image causes the charged particles, suspended in a nonconductive liquid, to move by electrophoresis. The charge of the latent electrostatic image is thus neutralized by the oppositely charged particles. The theory and physics of electrophoretic development with liquid toners are well described in many books and publications.

If a reimageable photoreceptor or an electrographic master is used, the toned image is transferred to paper (or other support). The paper is charged electrostatically, with the polarity chosen to cause the toner particles to transfer to the paper. Finally, the toned image is fixed to the paper. For self-fixing toners, residual liquid is removed from the paper by air-drying or heating. Upon evaporation of the solvent, these toners form a film bonded to the paper. For heat-fusible toners, thermoplastic polymers are used as part of the particle. Heating both removes residual liquid and fixes the toner to paper.

When used as ink jet imaging media, the recording elements or media typically comprise a substrate or a support material having on at least one surface thereof an ink-receiving or image-forming layer. If desired, in order to improve the adhesion of the ink receiving layer to the support, the surface of the support may be corona-discharge-treated prior to applying the solvent-absorbing layer to the support or, alternatively, an undercoating, such as a layer formed from a halogenated phenol or a partially hydrolyzed vinyl chloride-vinyl acetate copolymer, may be applied to the surface of the support. The ink receiving layer is preferably coated onto the support layer from water or water-alcohol solutions at a dry thickness ranging from 3 to 75 micrometers, preferably 8 to 50 micrometers.

Any known ink jet receiver layer may be used in combination with the external polyester-based barrier layer useful in the present invention. For example, the ink receiving layer may consist primarily of inorganic oxide particles such as silicas, modified silicas, clays, aluminas, fusible beads such as beads comprised of thermoplastic or thermosetting polymers, non-fusible organic beads, or hydrophilic polymers such as naturally-occurring hydrophilic colloids and gums such as gelatin, albumin, guar, xantham, acacia, chitosan, starches and their derivatives; derivatives of natural polymers such as functionalized proteins, functionalized gums and starches, and cellulose ethers and their derivatives; and synthetic polymers such as polyvinyloxazoline, polyvinylmethyloxazoline, polyoxides, polyethers, poly(ethylene imine), poly(acrylic acid), poly(methacrylic acid), n-vinyl amides including polyacrylamide and polyvinylpyrrolidone, and poly(vinyl alcohol), its derivatives and copolymers; and combinations of these materials. Hydrophilic polymers, inorganic oxide particles, and organic beads may be present in one or more layers on the support and in various combinations within a layer.

A porous structure may be introduced into ink receiving layers comprised of hydrophilic polymers by the addition of ceramic or hard polymeric particulates, by foaming or blowing during coating, or by inducing phase separation in the layer through introduction of non-solvent. In general, it is preferred for the base layer to be hydrophilic, but not porous. This is especially true for photographic quality prints, in which porosity may cause a loss in gloss. In particular, the ink receiving layer may consist of any hydrophilic polymer or combination of polymers with or without additives as is well known in the art.

If desired, the ink receiving layer may be overcoated with an ink-permeable, anti-tack protective layer such as, for example, a layer comprising a cellulose derivative or a cationically-modified cellulose derivative or mixtures thereof. An especially preferred overcoat is poly β-1,4-anhydro-glucose-g-oxyethylene-g-(2′-hydroxypropyl)-N,N-dimethyl-N-dodecylammonium chloride. The overcoat layer is non porous, but is ink permeable and serves to improve the optical density of the images printed on the element with water-based inks. The overcoat layer may also protect the ink receiving layer from abrasion, smudging, and water damage. In general, this overcoat layer may be present at a dry thickness of 0.1 to 5 μm, preferably 0.25 to 3 μm.

In practice, various additives may be employed in the ink receiving layer and overcoat. These additives include surface active agents such as surfactant(s) to improve coatability and to adjust the surface tension of the dried coating, acid or base to control the pH, antistatic agents, suspending agents, antioxidants, hardening agents to cross-link the coating, antioxidants, UV stabilizers, light stabilizers. In addition, a mordant may be added in small quantities (2%-110% by weight of the base layer) to improve waterfastness. Useful mordants are disclosed in U.S. Pat. No. 5,474,843.

The layers described above, including the ink receiving layer and the overcoat layer, may be coated by conventional coating means onto a transparent or opaque support material commonly used in this art. Coating methods may include, but are not limited to, blade coating, wound wire rod coating, slot coating, slide hopper coating, gravure, curtain coating. Some of these methods allow for simultaneous coatings of both layers, which is preferred from a manufacturing economic perspective.

The DRL (dye receiving layer) is coated over the tie layer or TL at a thickness ranging from 0.1-10 μm, preferably 0.5-5 μm. There are many known formulations that may be useful as dye receiving layers. The primary requirement is that the DRL is compatible with the inks which it will be imaged so as to yield the desirable color gamut and density. As the ink drops pass through the DRL, the dyes are retained or mordanted in the DRL, while the ink solvents pass freely through the DRL and are rapidly absorbed by the TL. Additionally, the DRL formulation is preferably coated from water, exhibits adequate adhesion to the TL, and allows for easy control of the surface gloss.

For example, Misuda et al in U.S. Pat. Nos. 4,879,166; 5,264,275; 5,104,730; 4,879,166, and Japanese Patents 1,095,091; 2,276,671; 2,276,670; 4,267,180; 5,024,335; and 5,016,517 disclose aqueous based DRL formulations comprising mixtures of psuedo-bohemite and certain water soluble resins. Light in U.S. Pat. Nos. 4,903,040; 4,930,041; 5,084,338; 5,126,194; 5,126,195; and 5,147,717 discloses aqueous-based DRL formulations comprising mixtures of vinyl pyrrolidone polymers and certain water-dispersible and/or water-soluble polyesters, along with other polymers and addenda. Butters et al in U.S. Pat. Nos. 4,857,386 and 5,102,717 disclose ink-absorbent resin layers comprising mixtures of vinyl pyrrolidone polymers and acrylic or methacrylic polymers. Sato et al in U.S. Pat. No. 5,194,317 and Higuma et al in U.S. Pat. No. 5,059,983 disclose aqueous-coatable DRL formulations based on poly(vinyl alcohol). Iqbal in U.S. Pat. No. 5,208,092 discloses water-based DRL formulations comprising vinyl copolymers that are subsequently cross-linked. In addition to these examples, there may be other known or contemplated DRL formulations that are consistent with the aforementioned primary and secondary requirements of the DRL, all of which fall under the spirit and scope of the current invention.

The preferred DRL is 0.1-10 micrometers thick and is coated as an aqueous dispersion of 5 parts alumoxane and 5 parts poly(vinyl pyrrolidone). The DRL may also contain varying levels and sizes of matting agents for the purpose of controlling gloss, friction, and/or fingerprint resistance, surfactants to enhance surface uniformity and to adjust the surface tension of the dried coating, mordanting agents, antioxidants, UV absorbing compounds, light stabilizers.

Although the ink-receiving elements as described above may be successfully used to achieve the objectives of the present invention, it may be desirable to overcoat the DRL for the purpose of enhancing the durability of the imaged element. Such overcoats may be applied to the DRL either before or after the element is imaged. For example, the DRL may be overcoated with an ink-permeable layer through which inks freely pass. Layers of this type are described in U.S. Pat. Nos. 4,686,118; 5,027,131; and 5,102,717. Alternatively, an overcoat may be added after the element is imaged. Any of the known laminating films and equipment may be used for this purpose. The inks used in the aforementioned imaging process are well known, and the ink formulations are often closely tied to the specific processes, that is, continuous, piezoelectric, or thermal. Therefore, depending on the specific ink process, the inks may contain widely differing amounts and combinations of solvents, colorants, preservatives, surfactants, and humectants. Inks preferred for use in combination with the image recording elements used with the present invention are water-based, such as those currently sold for use in the Hewlett-Packard Desk Writer 560C printer. However, it is intended that alternative embodiments of the image-recording elements as described above, which may be formulated for use with inks which are specific to a given ink-recording process or to a given commercial vendor, fall within the scope of the present invention.

Smooth opaque paper supports are useful in combination with silver halide images because the contrast range of the silver halide image is improved, and show through of ambient light during image viewing is reduced. The preferred photographic element used in this invention is directed to a silver halide photographic element capable of excellent performance when exposed by either an electronic printing method or a conventional optical printing method. An electronic printing method comprises subjecting a radiation sensitive silver halide emulsion layer of a recording element to actinic radiation of at least 104 ergs/cm² for up to 100μ seconds duration in a pixel-by-pixel mode wherein the silver halide emulsion layer is comprised of silver halide grains as described above. A conventional optical printing method comprises subjecting a radiation sensitive silver halide emulsion layer of a recording element to actinic radiation of at least 10⁻⁴ ergs/cm² for 10⁻³ to 300 seconds in an imagewise mode wherein the silver halide emulsion layer is comprised of silver halide grains as described above. This invention, in a preferred embodiment, utilizes a radiation-sensitive emulsion comprised of silver halide grains (a) containing greater than 50 mole percent chloride based on silver, (b) having greater than 50 percent of their surface area provided by {100} crystal faces, and (c) having a central portion accounting for from 95 to 99 percent of total silver and containing two dopants selected to satisfy each of the following class requirements: (i) a hexacoordination metal complex which satisfies the formula:

[ML₆]ⁿ (I)

wherein n is zero, −1, −2, −3, or −4; M is a filled frontier orbital polyvalent metal ion, other than iridium; and L₆ represents bridging ligands which may be independently selected, provided that at least four of the ligands are anionic ligands, and at least one of the ligands is a cyano ligand or a ligand more electronegative than a cyano ligand; and (ii) an iridium coordination complex containing a thiazole or substituted thiazole ligand. Preferred photographic imaging layer structures are described in EP Publication 1 048 977. The photosensitive imaging layers described therein provide particularly desirable images on the support used with this invention.

### EXAMPLES

The following examples illustrate the practice of this invention. They are not intended to be exhaustive of all possible variations of the invention. Parts and percentages are by weight unless otherwise indicated.

### Example 1

In this example, polypropylene foam of caliper 6.0 mil and density 0.53 g/cm³ was obtained from Berwick Industries, Berwick, Pa. This was then extrusion resin coated on both sides using a flat sheet die. The upper flange layer on the face or image side of the foam was coextrusion coated. The layer closer to the foam was coated at 36 g/m² coverage, at a melt temperature of 274° C., and comprised approximately 10% anatase titanium dioxide, 20% Mistron CB Talc (from Luzenac America), 20% PA609 (amorphous organic polymer from Exxon Mobil) and 50% PF611 (polypropylene homopolymer—extrusion coating grade from Basell). A skin layer was coated onto the upper flange layer on the side furthest from the foam at 107 g/m² coverage, at a melt temperature of 300 C, and comprised (approximately) 18% titanium dioxide, 4.5% ZnO, and 78.5% D4002 P (low density polyethylene from Eastman Chemical Company). The lower flange layer on the wire side or side opposite the imaging layer of the foam was monoextrusion coated at 300 C melt temperature. The lower flange layer coating was at 485 g/m² coverage and comprised (approximately) 10% anatase titanium dioxide, 20% Mistron CB Talc, 20% PA609 and 50% PF611. The melt extruder polypropylene was extruded from a coathanger flat sheet die. The polymer was extruded into a nip formed by a chill roller and a pressure roller with the polypropylene foam core layer being the primary web support that was against the pressure roller and the molten polypropylene flange layer against the chill roller surface. The surface of the backside chill roller has been previously engraved with a reverse image of the desired indicia (information) to be embossed. The embossed patterns of indicia basically comprise raised or recessed areas of one roughness and a background area of a different height with a different roughness. When the molten polymer enters the nip formed the pressure roller and the polypropylene foam core and the chill roller, the pressure in the nip forces the fluid polymer to conform to the surface. As the polymer cools and solidifies, it replicates the surface with the different height and roughness profiles.

### Example 2

Polypropylene foam of caliper 6.0 mil and density 0.53 g/cm³ was obtained from Berwick Industries, Berwick, Pa. The polypropylene foam was printed on the backside with an ink logo indicia and passed through a dryer to remove the solvent. The printed foam core was then extrusion resin coated on both sides using a flat sheet die. The upper flange layer or the face or image side of the foam was coextrusion coated. The layer closer to the foam was coated at 36 g/m² coverage, at a melt temperature of 274° C., and comprised (approximately) 10% anatase titanium dioxide, 20% Mistron CB Talc (from Luzenac America), 20% PA609 (amorphous organic polymer from Exxon Mobil) and 50% PF611 (polypropylene homopolymer—extrusion coating grade from Basell). The skin layer was coated at 107 g/m coverage, at a melt temperature of 300 C, and comprised (approximately) 18% titanium dioxide, 4.5% ZnO, and 78.5% D4002 P (low density polyethylene from Eastman Chemical Company). The lower flange layer or the wire side of the foam or side opposite the imaging layer was mono-extrusion coated at 300 C melt temperature. The lower flange layer coating was at 485 g/m² coverage and comprised (approximately) 10% anatase titanium dioxide, 20% Mistron CB Talc, 20% PA609 and 50% PF611. The melt extruder polypropylene was extruded from a coathanger flat sheet die. The polymer was extruded into a nip formed by a chill roller and a pressure roller with the polypropylene foam core sheet being the primary web support that was against the pressure roller and the molten polypropylene flange layer against the chill roller surface.

### Example 3

This sample was prepared similar to example 2 except that the upper flange layer was a sheet of voided biaxially oriented polypropylene that was adhered to the closed cell foam core layer with an adhesive layer of a melt extrudable metallocene plastomer that was coated at coverage of 84 g/m². The polymer was melted at 315 C and extrusion coated between the biaxially oriented sheet and the polyester sheet into a pressure nip. The top sheet used in this example was coextruded and biaxially oriented. The orientation was approximately eight times the cross direction and five times in the machine direction. The top sheet was melt extrusion laminated to the closed cell foam core layer using an metallocene catalyzed ethylene plastomer (SLP 9088) manufactured by Exxon Chemical Corp. The metallocene catalyzed ethylene plastomer had a density of 0.900 g/cc and a melt index of 14.0. The voided biaxially oriented sheet was 1.5 mils thick.

Top Sheet (Imaging Side)

A composite sheet consisting of 5 layers identified as L1, L2, L3, L4, and L5 was coated onto the top or image side of the closed cell foam core. L1 is the thin colored layer on the outside of the package to which the photosensitive silver halide layer was attached. L2 is the layer to which optical brightener and titanium dioxide was added. The optical brightener used was Hostalux KS manufactured by Ciba-Geigy. A coated extrusion grade anatase titanium dioxide was added to both L2 and L4. Table 3 below lists the characteristics of the layers of the top biaxially oriented sheet used in this example.

TABLE 3

| Layer | Material | Thickness, μm |
|---|---|---|
| L1 | Polyethylene + color concentrate | 0.75 |
| L2 | Polypropylene + 24% titanium dioxide + OB | 6.65 |
| L3 | Voided Polypropylene | 21 |
| L4 | Polypropylene + 18% titanium dioxide | 6.85 |
| L5 | Polypropylene | 0.76 |

On the backside, a lower flange layer of high density (0.930 g/cc) polyethylene was melt extruded at 315 C. The melt polymer was brought together into the nip in which the chill roll had an engraved logo indicia.

### Example 4

This sample was prepared similar to example 1 except the indicia were printed on the backside flange layer. The backside chill was a matte surface.

### Example 5 (Control)

A photographic paper support was produced by refining a pulp furnish of 50% bleached hardwood kraft, 25% bleached hardwood sulfite, and 25% bleached softwood sulfite through a double disk refiner, then a Jordan conical refiner to a Canadian Standard Freeness of 200 cc. To the resulting pulp furnish was added 0.2% alkyl ketene dimer, 1.0% cationic cornstarch, 0.5% polyamide-epichlorohydrin, 0.26 anionic polyacrylamide, and 5.0% titanium dioxide on a dry weight basis. An about 46.5 lbs. per 1000 sq. ft. (ksf) bone dry weight base paper was made on a fourdrinier paper machine, wet pressed to a solid of 42%, and dried to a moisture of 10% using steam-heated dryers achieving a Sheffield Porosity of 160 Sheffield Units and an apparent density 0.70 g/cc. The paper support was then surface sized using a vertical size press with a 10% hydroxyethylated cornstarch solution to achieve a loading of 3.3 wt. % starch. The surface sized support was calendered to an apparent density of 1.04 gm/cc. This paper support, or base, was then resin coated with 27 g/m² of low density polyethylene (0.917 g/cc from Eastman Chemical) containing rutile titanium dioxide (DuPont R104) on the top side and 27 g/m² of clear polyethylene (0.0924 g/cc) on the backside.

TABLE 1

| | | | | | Print |
|---|---|---|---|---|---|
| | | Flange | Indicia | | Accept- |
| Example | Core | layer | Method | Indicia Location | ability |
| 1 | Foam | Extruded | Embossed | Backside | OK |
| | | Polymer | | Flange layer | |
| 2 | Foam | Extruded | Print | Backside of | OK |
| | | Polymer | | Closed cell | |
| | | | | foam core layer | |
| 3 | Foam | BOPP* | Print | Backside of | OK |
| | | | | Closed cell | |
| | | | | foam core layer | |
| 4 | Foam | Extruded | Print | Backside Flange | OK |
| | | Polymer | | layer | |
| 5(Control) | Paper | Extruded | Print | Backside Flange | Poor |
| | | LDPE | | layer | |

BOPP represents biaxially oriented polypropylene
LDPE represents low density polyethylene

Table 1 provides a summary of print location for placing indicia on a closed cell foam core layer. As is noted, the indicia were embossed or printed in a variety of locations, all of which provided acceptable marking of the support.

The invention has been described in detail with particular reference to certain preferred embodiments thereof, but it will be understood that variations and modifications can be effected within the spirit and scope of the invention.

What is claimed is:

1. A method for placing indicia on a support for an imaging element comprising providing a support wherein said support comprises a closed cell foam core layer and adhered thereto at least one flange layer, wherein said closed cell foam core layer comprises a polymer that has been expanded through the use of a blowing agent, and placing indicia on said support, wherein said imaging element comprises said support and at least one imaging layer.

2. The method of claim 1 wherein said closed cell foam core layer comprises polyolefin polymer.

3. The method of claim 2, wherein said polyolefin polymer comprises polypropylene.

4. The method of claim 1 wherein said closed cell foam core layer has a thickness of from 25 to 350 μm.

5. The method of claim 1 wherein the modulus of said closed cell foam core layer comprises from 30 MPa to 1000 Mpa.

6. The method of claim 1 wherein said placing said indicia on said support comprises placing said indicia on at least one flange layer.

7. The method of claim 1 wherein said placing said indicia on said support comprises placing said indicia on said closed cell foam core layer.

8. The method of claim 1 wherein the modulus of said flange layers comprises from 700 MPa to 10500 MPa.

9. The method of claim 1 wherein said flange layers are integral with said closed cell foam core layer.

10. The method of claim 1 wherein said at least one flange layer has an opacity from 80 to 99 percent.

11. The method of claim 1 wherein said at least one flange layer has an opacity greater than 90 percent.

12. The method of claim 1, wherein said at least one flange layer further comprises pigment.

13. The method of claim 1, wherein said at least one flange layer further comprises talc.

14. The method of claim 1, wherein said at least one flange layer further comprises titanium dioxide pigment.

15. The method of claim 1 wherein said upper flange layer comprises paper.

16. The method of claim 15 wherein said paper flange layer comprises a caliper from 25 μm to 100 μm.

17. The method of claim 15 wherein said paper flange layer comprises a caliper from 30 μm to 70 μm.

18. The method of claim 15 wherein said upper flange layer comprises paper and wherein said lower flange layer comprises paper.

19. The method of claim 1 wherein said lower flange layer comprises paper.

20. The method of claim 19 wherein said paper flange layer comprises a caliper from 25 μm to 100 μm.

21. The method of claim 19 wherein said paper flange layer comprises a caliper from 30 μm to 70 μm.

22. The method of claim 1 wherein said flange layer comprises a flange layer on the side of said support opposite said imaging layer.

23. The method of claim 22 wherein said flange layer on the side of said support opposite said imaging layer comprises a transparent flange layer.

24. The method of claim 1 wherein said at least one flange layer on the backside is transparent.

25. The method of claim 1 wherein said flange layers comprise polymer layers.

26. The method of claim 25, wherein said at least one flange layer comprises an oriented layer.

27. The method of claim 26 wherein said polymer flange layers comprise biaxially oriented polyolefin layers.

28. The method of claim 25 wherein said polymer flange layers comprise a caliper from 10 μm to 150 μm.

29. The method of claim 25 wherein said polymer flange layers comprise a caliper from 35 μm to 70 μm.

30. The method of claim 1 wherein said support has opacity from 80% to 99%.

31. The method of claim 1 wherein said support has a thickness of from 100 to 400 μm.

32. The method of claim 1 wherein the upper surface of said support has an average roughness of from 0.1 μm to 1.1 μm.

33. The method of claim 1 wherein the weight of said imaging member comprises less than 75% by weight of raw paper.

34. The method of claim 1 wherein the weight of said imaging member comprises less than 50% by weight of raw paper.

35. The method of claim 1 wherein said imaging layer comprises photosensitive silver halide.

36. The method of claim 1 wherein said imaging layer comprises an ink jet receiving layer.

37. The method of claim 1 wherein said imaging layer comprises a thermal dye receiving layer.

38. The method of claim 1 wherein said imaging layer comprises an electrophotographic layer.

39. The method of claim 1 further comprising polyethylene resin coatings on each side of said support.

40. The method of claim 1 wherein said placing indicia on said support comprises ink printing.

41. The method of claim 40 wherein said ink printing comprises aqueous ink.

42. The method of claim 40 wherein said ink printing comprises solvent-based ink.

43. The method of claim 40 wherein said placing indicia on said support comprises embossing.

44. The method of claim 1 wherein said indicia comprise machine detectable indicia, wherein said machine detectable indicia are not visible to the human eye under daylight illuminance.

45. The method of claim 44 wherein said machine detectable indicia comprise inks which respond to actinic radiation below 400 nanometers or above 700 nanometers.

46. The method of claim 44 wherein said indicia comprises a grid pattern.

47. A method for placing indicia on a support for an imaging element comprising providing a support wherein said support comprises a closed cell foam core layer and adhered thereto an upper flange layer and a lower flange layer, wherein said closed cell foam core layer comprises a polymer that has been expanded through the use of a blowing agent, and placing indicia on at least one of said upper and lower flange layer.

48. The method of claim 47 wherein said upper and lower flange layers have a modulus greater than the modulus of the closed cell foam core layer.

49. A method for placing indicia on a support for an imaging element comprising providing a support comprising a support wherein said support comprises a closed cell foam core layer and adhered thereto at least one flange layer, wherein said closed cell foam core layer comprises a polymer that has been expanded through the use of a blowing agent, and placing indicia on said closed cell foam core layer.

50. The method of claim 49 further comprising the step of adhering at least one flange layer to said indiciaed closed cell foam core layer.
